(19) United States
(12) Patent Application Publication
(10) Pub. No.: US 2026/0223058 A1
(43) Pub. Date: Jul. 30, 2026

(54) LOW OVERHEAD SIDELINK PRS MEASUREMENTS

(71) Applicant: TELEFONAKTIEBOLAGET LM ERICSSON (PUBL), Stockholm (SE)

(72) Inventors: Siva MURUGANATHAN, Stittsville (CA); Gustav LINDMARK, Linköping (SE); Florent MUNIER, Vastra Frolunda (SE); Peter HAMMARBERG, Molndal (SE); Ritesh SHREEVASTAV, Upplands Vasby (SE)

(21) Appl. No.: 19/157,400

(22) PCT Filed: Feb. 16, 2024
(86) PCT No.: PCT/IB2024/051524

§ 371 Date: Aug. 18, 2025

Related U.S. Application Data
(60) Provisional application No. 63/446,736, filed on Feb. 17, 2023.

(51) Int. Cl. H04W 64/00; H04W 72/25

(52) U.S. Cl. CPC H04W 64/00; H04W 72/25

(57) ABSTRACT

Systems and methods for performing sidelink (SL) positioning reference signal (PRS) time difference and round-trip time measurements and calculations are provided. A first wireless device transmits a first SL PRS to at least a second and third wireless device. The first wireless device receives a second SL PRS from the second wireless device and a third SL PRS from the third wireless device. The first wireless device can determine a first SL PRS based Rx-Tx measurement as a time difference between reception time of the second SL PRS and transmission time of the first SL PRS; and determine a second SL PRS based Rx-Tx measurement as a time difference between reception time of the third SL PRS and transmission time of the first SL PRS.

### CROSS REFERENCE TO RELATED APPLICATIONS

This application claims the benefit of U.S. Provisional Application No. 63/446,736 filed on Feb. 17, 2023, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system 5G/NR will support a diverse set of use cases and a diverse set of deployment scenarios. The later includes deployment at both low frequencies (e.g. 100s of MHz), similar to LTE today, and very high frequencies (e.g. mm waves in the tens of GHz). Besides the typical mobile broadband use case, NR is being developed to also support machine type communication (MTC), ultra-low latency critical communications (URLCC), side-link device-to-device (D2D) and other use cases.

Positioning and location services have been topics in LTE standardization since 3GPP Release 9. An objective was to fulfill regulatory requirements for emergency call positioning but other use case like positioning for Industrial Internet of Things (I-IoT) are also considered. Positioning in NR is supported by the example architecture shown in FIG. 1. LMF 108A represents the location management function entity in NR. There are also interactions between the LMF 108A and the gNodeB 110 via the NRPPa protocol. The interactions between the gNodeB 110 and the device (UE) 112 are supported via the Radio Resource Control (RRC) protocol, while the location node 108A interfaces with the UE 112 via the LTE positioning protocol (LPP). LPP is common to both NR and LTE technologies. Other network nodes, such as Access and Mobility Management Function (AMF) 108B and evolved Serving Mobile Location Center (e-SMLC) 108C, may be involved in positioning support.

It will be appreciated that while FIG. 1 shows gNB 110B and ng-eNB 110A, both may not always be present. It is noted that when both the gNB 110B and ng-eNB 110A are present, the NG-C interface is generally only present for one of them.

NR positioning since Release 16, based on the 3GPP NR radio-technology, has provided added value in terms of enhanced location capabilities. The operation in low and high frequency bands (i.e. below and above 6 GHz) and utilization of massive antenna arrays provide additional degrees of freedom to substantially improve the positioning accuracy. The possibility to use wide signal bandwidth in low and especially in high bands brings new performance bounds for user location for well-known positioning techniques based on OTDOA and UTDOA, Cell-ID or E-Cell-ID etc., utilizing timing measurements to locate a UE.

NR supports the following radio access technology (RAT)-dependent positioning methods.

DL-TDOA: The DL-TDOA positioning method makes use of the DL RSTD (and optionally DL PRS RSRP) of downlink signals received from multiple transmission points (TPs), at the UE. The UE measures the DL RSTD (and optionally DL PRS RSRP) of the received signals using assistance data received from the positioning server, and the resulting measurements are used along with other configuration information to locate the UE in relation to the neighbouring TPs.

Multi-RTT: The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

UL-TDOA: The UL-TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

DL-AoD: The DL-AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighbouring TPs.

UL-AoA: The UL-AoA positioning method makes use of the measured azimuth and zenith of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

NR-ECID: NR Enhanced Cell ID (NR E-CID) positioning refers to techniques which use additional UE measurements and/or NR radio resource and other measurements to improve the UE location estimate.

The positioning modes can be categorized as UE-assisted, UE-based, or standalone.

UE-Assisted: The UE performs measurements with or without assistance from the network and sends these measurements to the E-SMLC where the position calculation may take place.

UE-Based: The UE performs measurements and calculates its own position with assistance from the network.

Standalone: The UE performs measurements and calculates its own without network assistance.

Previous standardization work on sidelink (SL) ranging and positioning has focused on the communication aspects. From a positioning perspective, in previous 3GPP releases, the network has been catering for the need of positioning for the cellular system. Exploiting SL measurements in device positioning is therefore a new paradigm for positioning using 3GPP technology.

3GPP specified the LTE D2D (device-to-device) technology, also known as ProSe (Proximity Services) in the Release 12 and 13 of LTE. Later in Rel. 14 and 15, LTE V2X related enhancements targeting the specific characteristics of vehicular communications were specified. 3GPP started a new work item (WI) in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services would require enhancements of the NR system and a new NR sidelink framework could help to meet the stringent requirements in terms of latency and reliability. NR V2X system also expects to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the UEs (user equipment) and the NW (network), including support for standalone, network-less operation.

In 3GPP Rel. 17, discussions took place and National Security and Public Safety, NSPS, is considered to be one important use cases, which can benefit from the already developed NR sidelink features in Rel. 16. Therefore, it is most likely that 3GPP will specify enhancements related to NSPS use case taking NR Rel. 16 sidelink as a baseline. Besides, in some scenarios NSPS services need to operate with partial or without network coverage, such as indoor firefighting, forest firefighting, earthquake rescue, sea rescue, etc. where the infrastructure is (partially) destroyed or not available, therefore, coverage extension is a crucial enabler for NSPS, for both NSPS services communicated between UE and cellular NW and that communicated between UEs over sidelink.

### SUMMARY

It is an object of the present disclosure to obviate or mitigate at least one disadvantage of the prior art.

There are provided systems and methods for performing SL PRS time difference and round-trip time measurements and calculations.

In a first aspect, there is provided a first wireless device comprising a radio interface and processing circuitry. The first wireless device can be configured to transmit a first sidelink (SL) positioning reference signal (PRS) to at least a second wireless device and a third wireless device. The first wireless device receives a second SL PRS from the second wireless device and a third SL PRS from the third wireless device. The first wireless device determines a first SL PRS based Rx-Tx measurement associated with the second wireless device as a time difference between reception time of the second SL PRS and transmission time of the first SL PRS; and determines a second SL PRS based Rx-Tx measurement associated with the third wireless device as a time difference between reception time of the third SL PRS and transmission time of the first SL PRS.

In some embodiments, the first wireless device can transmit, to a network node, one or more of the first SL PRS based Rx-Tx measurement associated with the second wireless device and the second SL PRS based Rx-Tx measurement associated with the third wireless device.

In some embodiments, the first wireless device further calculates a round trip time (RTT) associated with the first and second wireless devices as a time difference between the first SL PRS based Rx-Tx measurement and a third SL PRS based Rx-Tx measurement, wherein the third SL PRS based Rx-Tx measurement is a time difference between transmission time of the second SL PRS by the second wireless device and reception time of the first SL PRS by the second wireless device. In some embodiments, the third SL PRS based Rx-Tx measurement (associated with the second wireless device) is received from the second wireless device.

In some embodiments, the first wireless device further calculates a round trip time (RTT) associated with the first and third wireless devices as a time difference between the first SL PRS based Rx-Tx measurement and a fourth SL PRS based Rx-Tx measurement, wherein the fourth SL PRS based Rx-Tx measurement is a time difference between transmission time of the third SL PRS by the third wireless device and reception time of the first SL PRS by the third wireless device.

In some embodiments, the first, second and third wireless devices belong to a wireless device group. The first SL PRS can be broadcast to all wireless devices in the wireless device group.

In some embodiments, the first wireless device obtains resource allocation information associated with the first SL PRS. The first SL PRS can be transmitted in accordance with the resource allocation. The resource allocation can be received from at least one of a network node and/or a SL positioning server wireless device.

In another aspect, there is provided a second wireless device comprising a radio interface and processing circuitry. The second wireless device can be configured to receive a first sidelink (SL) positioning reference signal (PRS) from a first wireless device, and to transmit a second SL PRS to the first wireless device and at least a third wireless device in response to receiving the first SL PRS. The second wireless device determines a third SL PRS based Rx-Tx measurement associated with the first wireless device as a time difference between transmission time of the second SL PRS by the second wireless device and reception time of the first SL PRS by the second wireless device.

In some embodiments, the second wireless device can transmit the third SL PRS based Rx-Tx measurement to the first wireless device.

In some embodiments, the second wireless device can receive a third SL PRS from the third wireless device. The second wireless device can determine a SL PRS based Rx-Tx measurement associated with the third wireless device similar to as described for the first wireless device.

In some embodiments, the second wireless device obtains resource allocation information associated with the second SL PRS. The second SL PRS can be transmitted in accordance with the resource allocation. The resource allocation can be received from at least one of a network node and/or a SL positioning server wireless device (e.g. the first wireless device).

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example of NR positioning architecture;

FIG. 2 is an example communication system;

FIG. 3 is an example UE Rx time and UE Tx time for SL PRS;

FIG. 4 is an example illustrating pair-wise SL multi-RTT;

FIG. 5 is an example illustrating group-based SL multi-RTT;

FIG. 6 is an example illustrating double-sided SL multi-RTT;

FIG. 7 is a flow chart illustrating a method performed by a wireless device;

FIG. 8 is a flow chart illustrating a method performed by a SL positioning server device;

FIG. 9 is a flow chart illustrating a method performed by a network node;

FIG. 10 is a block diagram of an example wireless device;

FIG. 11 is a block diagram of an example network node;

FIG. 12 is a block diagram of an example host;

FIG. 13 is a block diagram illustrating an example virtualization environment; and

FIG. 14 is a communication diagram of a host communicating via a network node with a UE.

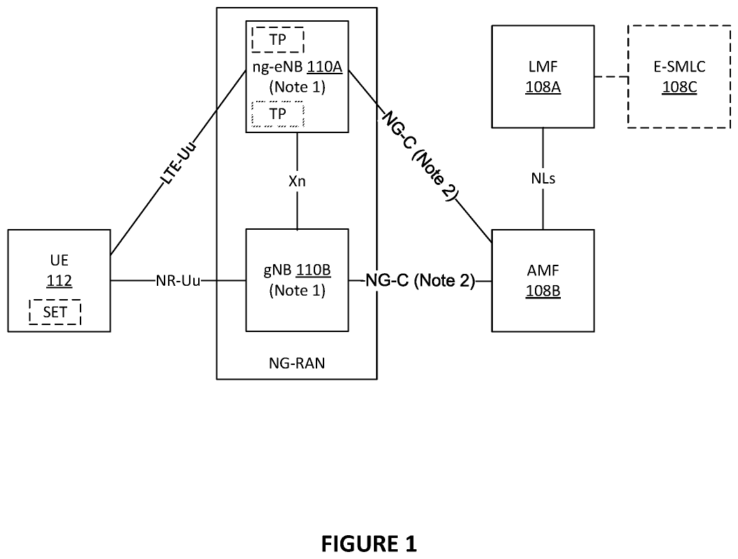

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

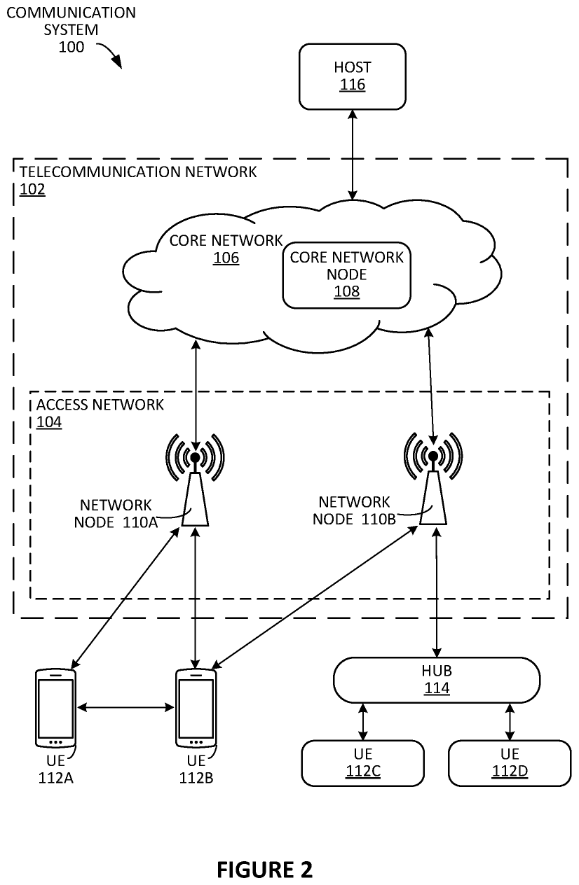

FIG. 2 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110A and 110B (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g. core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Location Management Function (LMF), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g. UE 112C and/or 112D) and network nodes (e.g. network node 110B). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110B. The hub 114 may also allow for a different communication scheme and/or schedule between the hub 114 and UEs (e.g. UE 112C and/or 112D), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110B. In other embodiments, the hub 114 may be a non-dedicated hub—that is, a device which is capable of operating to route communications between the UEs and network node 110B, but which is additionally capable of operating as a communication start and/or end point for certain data channels.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

Returning to the discussion of positioning, in the current positioning support of LTE and NR systems, sidelink based ranging and positioning has been agreed to as a topic for Release 18 discussion. With ranging, it in general implies that both distance and angle information about the wireless link between two devices is derived. In a Rel-18 work item, it has been assumed that SL PRS will be used as the reference signal for performing SL measurements between UEs.

In use cases requiring the computation of the location of a group of UEs via SL positioning and/or SL ranging, a large number of SL PRS transmissions may be needed, particularly when the number of the UEs in the group is large. A large number of SL PRS transmissions will incur heavy reference signal overhead and can reduce the energy efficiency for the UEs in the group. In addition, a large number of SL PRS transmissions may cause increased interference to nearby SL UEs.

Hence, how to reduce the SL PRS overhead and reduce the interference when computing the location of a group of UEs using SL measurements is an open problem to be addressed.

Accordingly, some embodiments disclosed herein are directed towards low overhead group-based SL multi-RTT procedures. In some embodiments, each UE in the group may only need to transmit a SL PRS once, which can help reduce the SL PRS overhead. Aspects and procedures associated with allocating resources for group-based SL multi-RTT will be described. SL resource allocation strategies are considered for both network-centric resource allocation and UE-autonomous resource allocation scenarios.

### SL UE Rx-Tx Measurement Definitions

The UE Rx-Tx measurement for UU positioning is defined in 3GPP TS 38.215 as follows:

The UE Rx-Tx time difference is defined as T_{UE-RX}−T_{UE-TX}

Where:

T_{UE-RX} is the UE received timing of downlink subframe #i from a Transmission Point (TP) [18], defined by the first detected path in time.

T_{UE-TX} is the UE transmit timing of uplink subframe #j that is closest in time to the subframe #i received from the TP.

Multiple DL PRS or CSI-RS for tracking resources, as instructed by higher layers, can be used to determine the start of one subframe of the first arrival path of the TP.

For frequency range 1, the reference point for T_{UE-RX} measurement shall be the Rx antenna connector of the UE and the reference point for T_{UE-TX} measurement shall be the Tx antenna connector of the UE. For frequency range 2, the reference point for T_{UE-RX} measurement shall be the Rx antenna of the UE and the reference point for T_{UE-TX} measurement shall be the Tx antenna of the UE.

As per Clause 8 of TS 38.214, slots in which the symbols configured for SL (as configured via sl-StartSymbol and sl-LengthSymbols) that are not semi-statically configured as UL cannot be included in the set of slots that may belong to a sidelink resource pool. Hence, the existing definition of using downlink subframe #i and uplink subframe #j to define Rx-Tx time difference is not suitable for defining SL PRS based Rx-Tx measurement. This is because SL PRS transmission(s) and reception(s) have to take place during symbols that are semi-statically configured as UL and meeting other conditions described in Clause 8 of TS 38.214.

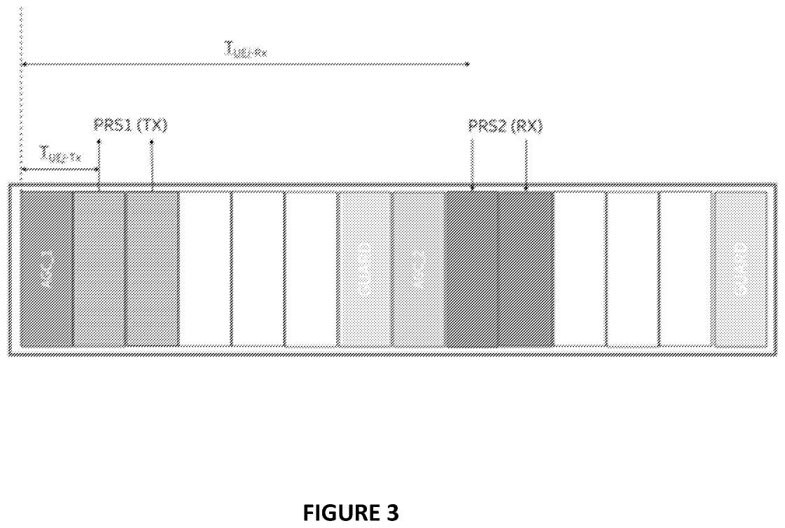

To define SL PRS based Rx-Tx time difference measurement performed by UE j corresponding to another UE i, one approach is to redefine the UE Rx time (denoted as T_{UE}_{ᵢ}_{-Rx}) and UE Tx time (denoted as T_{UE}_{ⱼ}_{-Tx}) at the symbol level. FIG. 3 is an example illustrating UE Rx time and UE Tx time for SL PRS. The UE Rx time for SL PRS reception from another UE i can be defined as:
T_{UE}_{ᵢ}_{-Rx}->the UE j's received timing of SL PRS from another UE i defined by the first detected path in time in slot k containing the received SL PRS from UE i.

Similarly, the UE Tx time for SL PRS transmission can be defined as:
T_{UE}_{ⱼ}_{-Tx}->the UE j's transmission timing of its own SL PRS that is closest in time to slot k.

Using these definitions, SL PRS based Rx-Tx time difference measurement at UE j can be computed as Rxᵢ−Txⱼ=T_{UE}_{ᵢ}_{-Rx}−T_{UE}_{ⱼ}_{-Tx}. The RTT (round trip time) between UE j and UE i, denoted as RTT_{i,j}, can be computed by taking the difference between the SL PRS based Rx-Tx time difference measurements at UEs j and i:

$${RTT}_{i , j} = ( {Rx}_{j} - {Tx}_{i} ) - ( {Rx}_{i} - {Tx}_{j} )$$

Although the embodiments described herein are presented in terms of multi-RTT measurements, these embodiments are not limiting and are applicable to other sidelink PRS based measurements which can involve measurements between two SL UEs, such SL PRS based RSTD measurement, SL PRS based RTOA measurements, etc.

### Pair-Wise Sidelink Multi-RTT

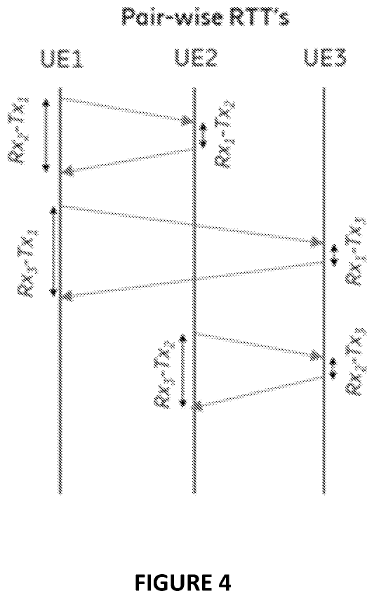

One approach to achieve multi-RTT based measurements in sidelink (SL) is to perform pair-wise SL multi-RTT between pairs of UEs. FIG. 4 illustrates an example of pair-wise SL multi-RTT involving three UEs. In the pair-wise SL multi-RTT example of FIG. 4, for each pair of UEs i,j∈{1,2,3}, the following UE procedures are involved:
UE i transmits SL PRS to UE j
UE j transmits SL PRS to UE i
UE i performs SL PRS based Rx-Tx measurement corresponding to UE j (denoted by Rxⱼ−Txᵢ)

UE j performs SL PRS based Rx-Tx measurement corresponding to UE i (denoted by Rxᵢ−Txⱼ)

RTT between each pair of UE i and UE j is then calculated using Rxⱼ−Txᵢ and Rxᵢ−Txⱼ

To compute SL multi-RTT using the pair-wise approach, there will be 2*Nₚₐᵢᵣₛ number of SL PRS transmissions needed from the UEs participating in SL multi-RTT, where Nₚₐᵢᵣₛ is the number of UE pairs. In the example of FIG. 4, the number of UE pairs Nₚₐᵢᵣₛ=3, and hence, there will be 6 different SL PRS transmissions needed. If the number of UEs involved in SL multi-RTT is large, then the number of SL PRS transmissions needed will be much larger and will result in more SL PRS overhead and potentially higher interference to other SL UEs.

It is noted that in this embodiment, UE1, for example, transmits a first SL PRS to UE2 and a second (e.g. different) SL PRS to UE3. UE1, for example, can then determine a first SL PRS based Rx-Tx measurement associated with UE2 and a second SL PRS based Rx-Tx measurement associated with UE3.

### Group-Based Sidelink Multi-RTT

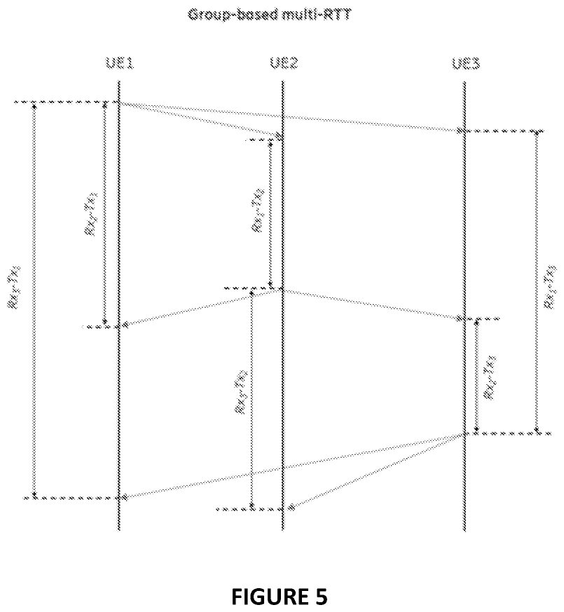

When compared to the pair-wise multi-RTT approach, a more efficient way to perform SL multi-RTT can be to follow a group-based approach where each UE participating in the multi-RTT only transmits a SL PRS once. An example of group-based SL multi-RTT with three UEs is illustrated in FIG. 5. In the group-based SL multi-RTT example of FIG. 5, the following UE procedures are involved:
UE i∈{1,2,3} transmits one SL PRS to all other UEs
Each of the other UEs j≠i performs SL PRS based Rx-Tx measurement corresponding to UE i (denoted by Rxᵢ−Txⱼ)
RTT between each pair of UE i and UE j is then calculated using Rxⱼ−Txₗ and Rxᵢ−Txⱼ

To compute SL multi-RTT using the group-based SL multi-RTT approach, there will be N_{UE} number of SL PRS transmissions needed from the UEs participating in group-based SL multi-RTT, where N_{UE} is the number of UEs in the group. In the example of FIG. 5, the number of UEs is N_{UE}=3, and hence, there will be only 3 different SL PRS transmissions needed. Hence, compared to the pair-wise SL multi-RTT approach of FIG. 4, the number of different SL PRS transmissions needed is reduced by half which leads to much lower SL PRS overhead and lower interference to other SL UEs. If the number of UEs involved in the group-based SL multi-RTT is larger, then the overhead savings and interference reduction achieved by the group-based SL multi-RTT approach is much larger.

It is noted that in this embodiment, UE1, for example, performs a single transmission of a first SL PRS. That first SL PRS can be received by one or more other UEs (e.g. UE2 and UE3) in the group. Each of the other UEs can then determine a SL PRS based Rx-Tx measurement associated with UE1.

### Resource Allocation for Pair-Wise or Group-Based Sidelink Multi-RTT

With regards to allocating SL PRS resources for either one of the pair-wise or group-based multi-RTT approach, each UE in the group needs to know when to transmit its SL PRS(s) and also when to receive the SL PRS(s) corresponding to each other UE in the group. SL PRS resource allocation for group-based (or pair-wise) sidelink multi-RTT can be performed either using a network-centric approach (referred to as resource allocation Scheme 1 henceforth) or a via UE autonomous SL PRS resource allocation (referred to as resource allocation Scheme 2 henceforth). In the network-centric approach, the network can allocate the resources to the group of UEs. In the UE centric approach, one of the UEs in the group or another UE outside the group may allocate the resources to the group of UEs. In addition, resource allocation for the two approaches should be considered for both shared resource pool and dedicated resource pool, where:
a shared resource pool is a pool of resource which are shared for the purposes of sidelink communications and sidelink positioning, and
a dedicated resource pool is a pool of resources which is dedicated to sidelink positioning only.

The details of SL PRS resource allocation for both resource allocation schemes 1 and 2 are disclosed in the below embodiments.

### Resource Allocation for Network-Centric Resource Allocation Scheme (i.e., Scheme 1)

The group of UEs participating in SL multi-RTT is formed by a network node such as a Location server (e.g. an LMF), and the group of UEs may consist of any one or more of:
anchor UE(s),
SL Positioning Server UE,
single target UE, or a plurality of target UEs.

Once the group is formed, the network node signals the resources allocated for SL PRS along with a scheduling pattern; i.e explicit indication on which UE will transmit SL PRS first (and on which SL resource(s) it should transmit its SL PRS), which UE will transmit SL PRS second (and on which SL resource(s) it should transmit its SL PRS), and so on. The SL resources here may have any one or a combination of a symbol level granularity (one or more symbols allocated for SL PRS), a slot level granularity (which slot is allocated for SL PRS), and/or a subframe (which subframe is allocated for SL PRS).

Alternatively, the resources for SL PRS may be allocated in a more implicit manner. For instance, the resource allocation is performed in such a way that:
UE1 transmits from a first time instance (e.g., time1) to a second time instance (e.g., time2),
UE2 transmits from a third time instance (e.g., time3) to a fourth time instance (e.g., time4), and so on.

In one optional embodiment, the third time instance may immediately start after second time instance or, in other words, the time resource of the third time instance begins shortly after second time instance ends. In some other embodiments, there can be a preconfigured gap between the third time instance and the second time instance.

In some embodiments, the time instances and the corresponding UE identifiers are indicated as part of the resource allocation signalled from the network node to the UEs in the group.

In some embodiments, the same network node (e.g., the LMF) allocates resources to the UEs and also indicates the scheduling patterns (e.g., when each UE should transmit its SL PRS) or the times instance(s) in which each UE should transmit its SL PRS.

In some embodiments, the time gap between SL-PRS transmission from two UEs are separated by a guard time, which is given by the time needed to perform Automatic Gain Control (AGC). Such information can be made available from the UE (e.g. as part of UE capability reporting on how much time is needed to perform AGC) or the gNB to location server which takes this into account while preparing the scheduling pattern and/or for the SLPP configuration(s). Another timing aspect that can be provided (e.g. as part of UE capability signaling) is the minimum time that the UE takes to switch from performing SL measurements to starting to transmit. Such timing or processing/switching delays can also be taken into consideration while preparing the scheduling pattern or SLPP configurations.

In some other embodiments, a first network node (e.g. a gNB) allocates the resources to the group of UEs, and a second network node (e.g. a LMF) indicates the scheduling patterns or the time instances in which each UE should transmit its SL PRS to the group of UEs. In one embodiment, the second network node first indicates the scheduling patterns or the time instances in which each UE should transmit its SL PRS to the group of UEs; this is followed by the first network node indicating the allocated resources for SL PRS to the group of UEs.

In one example embodiment, the gNB indicates the resources allocated to SL PRS via a DCI or a MAC CE to each of the UEs in the group. In another embodiment, the gNB indicates the resources allocated to SL PRS via a group common DCI with a specific DCI format and RNTI which can be received by the group of UEs participating in group-based multi-RTT.

In one example embodiment, the LMF indicates the scheduling patterns or the time instance(s) to the UE via LPP signaling or a sidelink positioning protocol (SLPP) message encapsulated within an LPP message.

If the resource allocation is to be performed by a second network node (e.g., LMF); the second NW node may request to a first NW node (e.g. to gNB) the number of UEs in the group, the UE IDs, the scheduling pattern, etc. In some embodiments, the first network node provides the requested information to the second NW node. In some other embodiments, the first network node provides the allocated resource to the first NW node. Once receiving the requested information from the first network node, the second network node then would prepare the SLPP configuration and send the configuration to the to group of UEs.

In some embodiments, the scheduling pattern may be determined using a round robin algorithm.

### Resource Allocation for UE Autonomous SL PRS Resource Allocation Scheme (i.e., Scheme 2)

In SL PRS resource allocation scheme 2, the group is formed by a UE (e.g., target UE or SL UE Location server) and the group may consist of any one or more of:
anchor UE,
SL Positioning Server UE,
a single target UE, or a plurality of target UEs.

Once the group is formed, the UE which formed the group provides the scheduling pattern (i.e., explicit indication) including which UE will transmit SL PRS first, which UE will transmit SL PRS second, and so on.

In one embodiment, based upon such indication, each UE will select a SL PRS resource and broadcast the PRS configuration information (i.e., the time/frequency resource information) it is going to use to transmit SL PRS.

Alternatively, the resources for SL PRS may be allocated in a more implicit manner. For instance, the resource allocation is performed in such a way that:
UE1 transmits from a first time instance (e.g., time1) to a second time instance (e.g., time2),
UE2 transmits from a third time instance (e.g., time3) to a fourth time instance (e.g., time4), and so on.

In one optional embodiment, the third time instance may immediately start after the second time instance or, in other words, the time resource of the third time instance begins shortly after the second time instance ends. In some other embodiments, there can be a preconfigured gap between the third time instance and the second time instance.

### Group Formation

Regarding group formation, in some embodiments, the group can be formed by an Application layer which may not have any 3GPP specification impact.

In an alternative embodiment, the group can be preconfigured by the network node based upon UE discovery procedures depending on which UEs are in the proximity to form the group.

In yet another alternative embodiment, the SL server UE can determine the group based upon target UE proximity of other UEs to form the group.

### Double-Sided Sidelink Multi-RTT

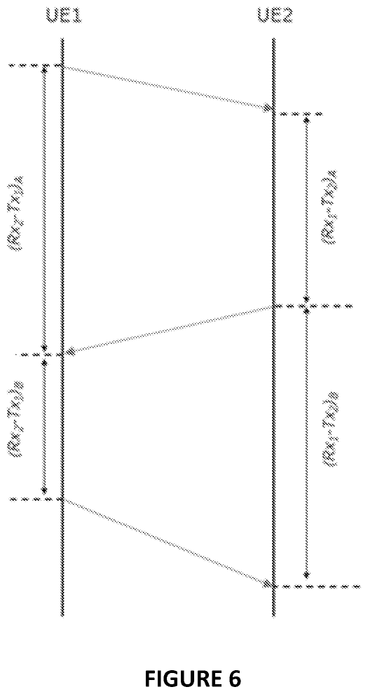

Although the above-described embodiments assume that each UE only transmits SL PRS once, these embodiments can be further extended to the case where a subset of UEs can transmit two SL PRSs. This can be useful for double-sided RTT which is robust against measurement errors due to UE clock stability (e.g. UE clock drift). An illustration of double-sided RTT is shown in FIG. 6, where one UE (UE2) transmits two SL PRSs and the other UE (UE1) only transmits one SL PRS. This way each UE can measure two versions of SL Rx-Tx measurements (the two versions are denoted as ‘A’ and ‘B’ in subscript in FIG. 6). Having two versions of the SL Rx-Tx measurements can provide robustness against measurement errors due to UE clock drift. Although FIG. 6 shows only two UEs, this extended embodiment is also applicable to a group of UEs where a subset of UEs transmits two SL PRSs while the other UEs (outside of that subset) transmit only one SL PRS.

The SL resource allocation, scheduling patterns, and other implicit indication proposed in the above embodiments can indicate that a subset of UEs will transmit two SL PRSs while the other UEs will transmit one SL PRS. This means the subset of UEs will be allocated two SL PRS resources while the other UEs will only be allocated a single SL PRS resource.

As a special case, in one optional embodiment, all UEs in the group are allocated two SL PRS resources instead of one. Hence, in this optional embodiment, each UE in the group will transmit two SL PRSs.

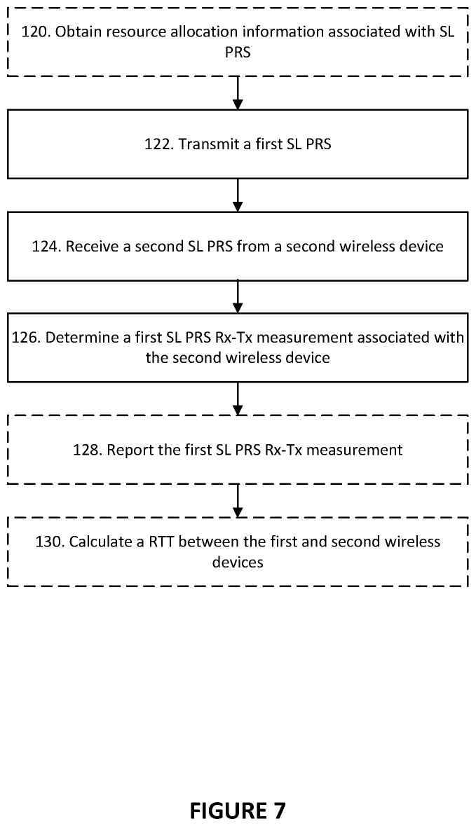

FIG. 7 is a flow chart illustrating an example method performed by a first wireless device, such as a UE 112 as described herein. The first wireless device can be one of a plurality of devices in a group of wireless devices. The method can include:

Step 120: Optionally, the first wireless device obtains resource allocation information associated with SL PRS. Optionally, the wireless device can also obtain configuration information such as group membership information. Optionally, the wireless device also obtains scheduling pattern information indicating which UE will transmit which SL PRS at which time instance.

The resource allocation and/or associated configuration information can be received from a network node and/or from another wireless device.

Step 122: The first wireless device transmits at least a first SL PRS in accordance with the resource allocation configuration. The first SL PRS can be transmitted to at least one other wireless device (e.g. a “second wireless device”) in the group or, alternatively, can be broadcast to more than one (e.g. all of the) wireless devices in the group.

Step 124: The first wireless device receives at least a second SL PRS from at least a second wireless device. In some embodiments, the first wireless device can receive a SL PRS from each of the wireless devices in the group (e.g. receive a third SL PRS from a third wireless device).

Step 126: The first wireless device determines at least a first SL PRS Rx-Tx measurement associated with at least the second wireless device. The SL PRS Rx-Tx measurement is a measurement of the time difference between transmission time of the first SL PRS and reception time of the second SL PRS. In some embodiments, the first wireless device can determine a SL PRS Rx-Tx measurement associated with each wireless device from which a SL PRS is received (e.g. determine a second SL PRS based Rx-Tx measurement associated with the third wireless device as a time difference between reception time of the third SL PRS and transmission time of the first SL PRS).

Step 128: Optionally, the first wireless device can report the first SL PRS Rx-Tx measurement. The report can be transmitted to one of: a wireless device in the group, a SL Positioning Server device, and/or a network node (such as an LMF). The SL PRS Rx-Tx measurement(s) can be reported in order for one or more Round Trip Time (RTT) calculations to be performed.

Step 130: Optionally, the wireless device can receive at least a third SL PRS Rx-Tx measurement from at least a second wireless device. Optionally, the wireless device can calculate a RTT between the first and second wireless devices in accordance with the first SL PRS Rx-Tx measurement and the third (e.g. received) SL PRS Rx-Tx measurement. Optionally, the wireless device can then report the calculated RTT to a network node.

In some optional embodiments, the wireless device can be configured to further transmit another SL PRS to the second wireless device (e.g. for the “double-sided RTT” procedures). The wireless device can then determine a further SL PRS Rx-Tx measurement that is associated with the second wireless device. Optionally, the wireless device can compare the first SL PRS Rx-Tx measurement with the further SL PRS Rx-Tx measurement for various purposes as have been described herein.

It will be appreciated that one or more of the above steps can be performed simultaneously and/or in a different order. Also, steps illustrated in dashed lines are optional and can be omitted in some embodiments.

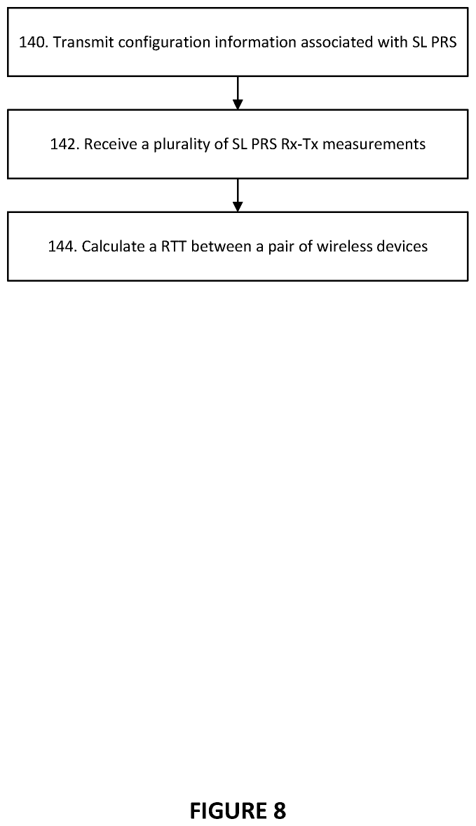

FIG. 8 is a flow chart illustrating an example method performed by a SL positioning server device. The SL positioning server device can be a wireless device, such as a UE 112 as described herein. In some embodiments, the SL positioning server device can be one of a plurality of devices in a group of wireless devices. The method can include:

Step 140: The SL positioning server transmits configuration information. In some embodiments, this can include transmitting resource allocation information associated with SL PRS and/or group membership configuration information to one or more wireless devices.

Step 142: The SL positioning server receives a plurality of SL PRS Rx-Tx measurements from one or more wireless devices.

Step 144: The SL positioning server calculates at least one RTT between a pair of wireless devices in accordance with the received SL PRS Rx-Tx measurements. Optionally, the calculated RTT can be reported to a network node.

It will be appreciated that one or more of the above steps can be performed simultaneously and/or in a different order. Also, steps illustrated in dashed lines are optional and can be omitted in some embodiments.

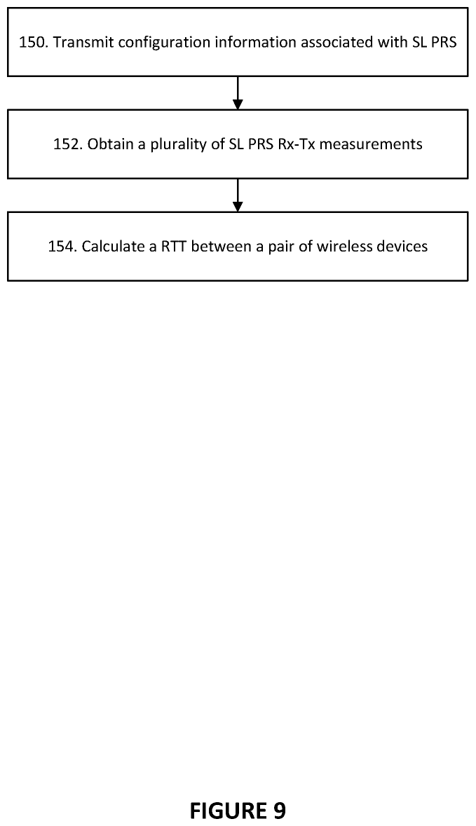

FIG. 9 is a flow chart illustrating an example method performed by a network node such as gNB 110 and/or a core network node 108 (e.g. location server, LMF) as described herein. The method can include:

Step 150: The network node transmits configuration information. In some embodiments, this can include transmitting resource allocation information associated with SL PRS, scheduling pattern information, and/or group membership configuration information to one or more wireless devices.

Step 152: The network node obtains a plurality of SL PRS Rx-Tx measurements associated with one or more wireless devices.

Step 154: The network node calculates at least one RTT between a pair of wireless devices in accordance with the received SL PRS Rx-Tx measurements.

It will be appreciated that one or more of the above steps can be performed simultaneously and/or in a different order. Also, steps illustrated in dashed lines are optional and can be omitted in some embodiments.

It will be appreciated that in some embodiments, a wireless device 112 can communicate (e.g. transmit/receive messages) directly with a network node such as location server 108. In other embodiments, messages and signals between the entities may be communicated via other nodes, such as radio access node (e.g. gNB, eNB) 110.

The SL-RTT positioning methods described herein make use of SL Rx-Tx time difference measurements performed by a pair of UEs (e.g. target UE and anchor UE). Both UEs measure the Rx-Tx time difference using the SL-PRS transmitted/received by the pair of UEs. The SL Rx-Tx time difference measurements performed by a pair of UEs can be used to define the RTT between the UEs, which can be converted into a range estimate between the pair of UEs.

As discussed, the pair of UEs may exchange SL PRS once (referred to as “single-sided RTT”) or multiple times (referred to as “double-sided RTT”). A UE may report multiple SL Rx-Tx time difference measurements for the same SL-PRS transmission and X number of different SL-PRS receptions, or report multiple SL Rx-Tx time difference measurements for the same SL-PRS reception and up to X number of different SL-PRS transmissions, or both.

With the various embodiments proposed herein, SL PRS overhead can be reduced when computing the location of a group of UEs via SL positioning and/or SL ranging. The proposed solutions can also reduce the interference caused by SL PRS to other SL UEs. Some embodiments can further improve the energy efficiency of the UEs as they need to transmit SL PRS less frequently.

Some embodiments include methods and procedures related to Pair-wise and/or Group-based SL multi-RTT. New measurement definitions have been provided for SL PRS based UE Rx-Tx time difference, which is then used to derive the RTT between different pairs of UEs.

Some embodiments include signaling aspects related to both network-centric and/or UE-autonomous SL resource allocation schemes. The procedures described in some embodiments may impact the conventional 3GPP specifications. For example, the signaling aspects between the LMF and the UE may impact the LPP specifications (TS 37.355). The signaling aspects between two UEs may impact the SLPP specifications. The signaling aspects between gNB and LMF may impact the NRPPa specifications (TS 38.455). The SL measurement related aspects may impact TS 38.215. Other UE procedural aspects may impact TS 38.214.

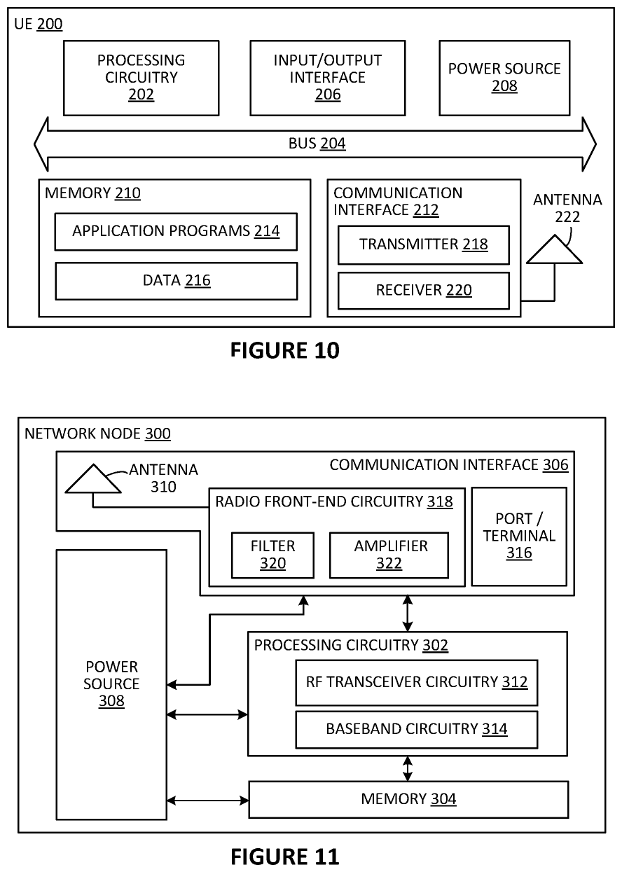

FIG. 10 shows a UE 200, which may be an embodiment of the UE 112 of FIG. 2 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 300, which may be an embodiment of the access node 110 or the core network node 108 of FIG. 2, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 11 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

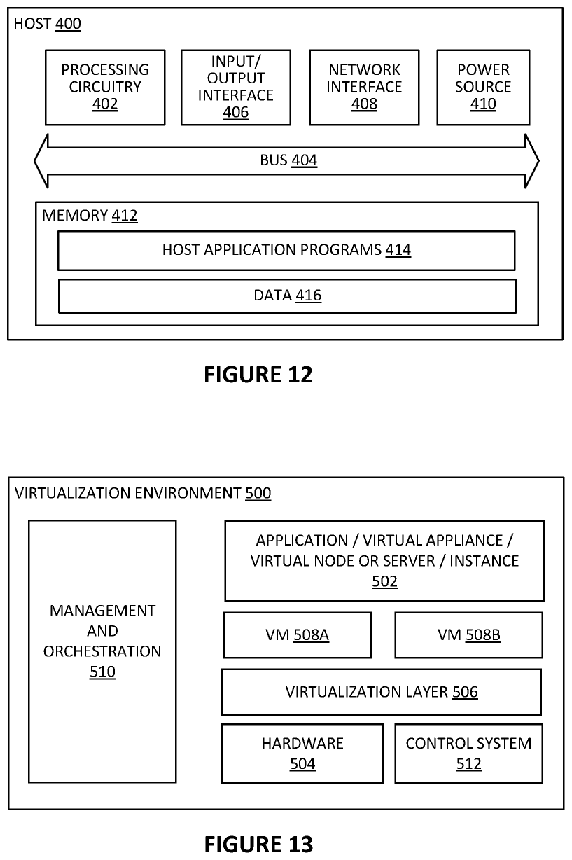

FIG. 12 is a block diagram of a host 400, which may be an embodiment of the host 116 of FIG. 2, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 10 and 11, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

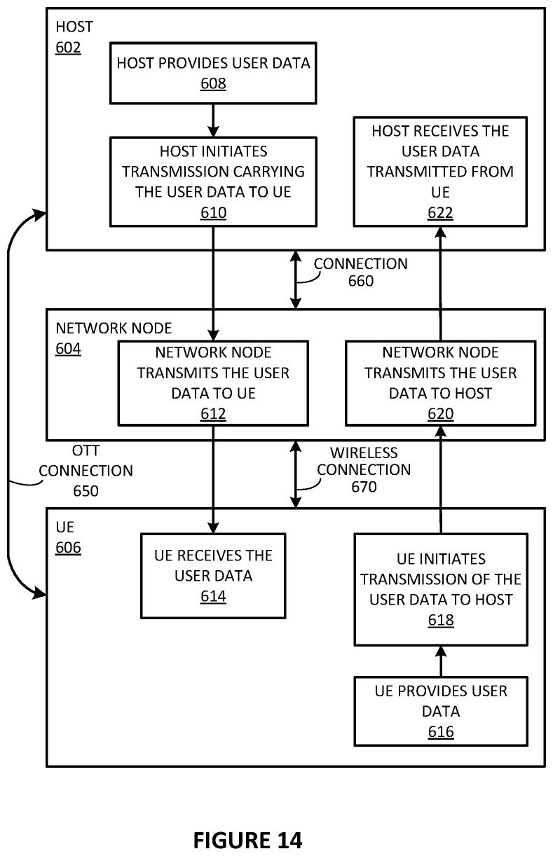

FIG. 14 shows a communication diagram of a host 602 communicating via a network node 604 with a UE 606 over a partially wireless connection in accordance with some embodiments. Example implementations, in accordance with various embodiments, of the UE (such as a UE 112A of FIG. 2 and/or UE 200 of FIG. 10), network node (such as network node 110A of FIG. 2 and/or network node 300 of FIG. 11), and host (such as host 116 of FIG. 2 and/or host 400 of FIG. 12) discussed in the preceding paragraphs will now be described with reference to FIG. 14.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 2) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the handling of colliding signals and/or channels and thereby provide benefits such as improving measurement latency and bypassing the measurement gap request procedure to improve positioning quality.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a first wireless device, the method comprising:
transmitting a first sidelink (SL) positioning reference signal (PRS) to at least a second wireless device and a third wireless device;
receiving a second SL PRS from the second wireless device;
receiving a third SL PRS from the third wireless device;
determining a first SL PRS based Rx-Tx measurement associated with the second wireless device as a time difference between reception time of the second SL PRS and transmission time of the first SL PRS; and
determining a second SL PRS based Rx-Tx measurement associated with the third wireless device as a time difference between reception time of the third SL PRS and transmission time of the first SL PRS.

2. The method of claim 1, further comprising, transmitting, to a network node, one or more of the first SL PRS based Rx-Tx measurement associated with the second wireless device and the second SL PRS based Rx-Tx measurement associated with the third wireless device.

3. The method of claim 1, further comprising, calculating a round trip time (RTT) associated with the first and second wireless devices as a time difference between the first SL PRS based Rx-Tx measurement and a third SL PRS based Rx-Tx measurement, wherein the third SL PRS based Rx-Tx measurement is a time difference between transmission time of the second SL PRS by the second wireless device and reception time of the first SL PRS by the second wireless device.

4. The method of claim 3, further comprising, receiving, from the second wireless device, the third SL PRS based Rx-Tx measurement associated with the second wireless device.

5. The method of any one of claims 1 to 4, further comprising, calculating a round trip time (RTT) associated with the first and third wireless devices as a time difference between the first SL PRS based Rx-Tx measurement and a fourth SL PRS based Rx-Tx measurement, wherein the fourth SL PRS based Rx-Tx measurement is a time difference between transmission time of the third SL PRS by the third wireless device and reception time of the first SL PRS by the third wireless device.

6. The method of any one of claims 1 to 5, wherein the first, second and third wireless devices belong to a wireless device group.

7. The method of claim 6, wherein the first SL PRS is broadcast to all wireless devices in the wireless device group.

8. The method of any one of claims 1 to 7, further comprising, obtaining resource allocation information associated with the first SL PRS.

9. The method of claim 8, wherein the first SL PRS is transmitted in accordance with the resource allocation.

10. The method of claim 8, wherein the resource allocation is received from at least one of a network node and a SL positioning server wireless device.

11. A first wireless device comprising a radio interface and processing circuitry configured to:
transmit a first sidelink (SL) positioning reference signal (PRS) to at least a second wireless device and a third wireless device;
receive a second SL PRS from the second wireless device;
receive a third SL PRS from the third wireless device;
determine a first SL PRS based Rx-Tx measurement associated with the second wireless device as a time difference between reception time of the second SL PRS and transmission time of the first SL PRS; and
determine a second SL PRS based Rx-Tx measurement associated with the third wireless device as a time difference between reception time of the third SL PRS and transmission time of the first SL PRS.

12. The first wireless device of claim 11, further configured to transmit, to a network node, one or more of the first SL PRS based Rx-Tx measurement associated with the second wireless device and the second SL PRS based Rx-Tx measurement associated with the third wireless device.

13. The first wireless device of claim 11, further configured to calculate a round trip time (RTT) associated with the first and second wireless devices as a time difference between the first SL PRS based Rx-Tx measurement and a third SL PRS based Rx-Tx measurement, wherein the third SL PRS based Rx-Tx measurement is a time difference between transmission time of the second SL PRS by the second wireless device and reception time of the first SL PRS by the second wireless device.

14. The first wireless device of claim 13, further configured to receive, from the second wireless device, the third SL PRS based Rx-Tx measurement associated with the second wireless device.

15. The first wireless device of any one of claims 11 to 14, further configured to calculate a round trip time (RTT) associated with the first and third wireless devices as a time difference between the first SL PRS based Rx-Tx measurement and a fourth SL PRS based Rx-Tx measurement, wherein the fourth SL PRS based Rx-Tx measurement is a time difference between transmission time of the third SL PRS by the third wireless device and reception time of the first SL PRS by the third wireless device.

16. The first wireless device of any one of claims 11 to 15, wherein the first, second and third wireless devices belong to a wireless device group.

17. The first wireless device of claim 16, wherein the first SL PRS is broadcast to all wireless devices in the wireless device group.

18. The first wireless device of any one of claims 11 to 17, further configured to obtain resource allocation information associated with the first SL PRS.

19. The first wireless device of claim 18, wherein the first SL PRS is transmitted in accordance with the resource allocation.

20. The first wireless device of claim 18, wherein the resource allocation is received from at least one of a network node and a SL positioning server wireless device.

21. A method performed by a second wireless device, the method comprising:
receiving a first sidelink (SL) positioning reference signal (PRS) from a first wireless device;
transmitting a second SL PRS to the first wireless device and at least a third wireless device in response to receiving the first SL PRS; and
determining a third SL PRS based Rx-Tx measurement associated with the first wireless device as a time difference between transmission time of the second SL PRS by the second wireless device and reception time of the first SL PRS by the second wireless device.

22. The method of claim 21, further comprising, transmitting the third SL PRS based Rx-Tx measurement to the first wireless device.

23. The method of any one of claims 21 to 22, further comprising, receiving a third SL PRS from the third wireless device.

24. The method of any one of claims 21 to 23, further comprising, obtaining resource allocation information associated with the second SL PRS.

25. The method of claim 24, wherein the second SL PRS is transmitted in accordance with the resource allocation.

26. The method of claim 24, wherein the resource allocation is received from at least one of a network node and the first wireless device.

27. The method of any one of claims 21 to 26, wherein the first, second and third wireless devices belong to a wireless device group.

28. A second wireless device comprising a radio interface and processing circuitry configured to:
receive a first sidelink (SL) positioning reference signal (PRS) from a first wireless device;
transmit a second SL PRS to the first wireless device and at least a third wireless device in response to receiving the first SL PRS; and
determine a third SL PRS based Rx-Tx measurement associated with the first wireless device as a time difference between transmission time of the second SL PRS by the second wireless device and reception time of the first SL PRS by the second wireless device.

29. The second wireless device of claim 28, further configured to transmit the third SL PRS based Rx-Tx measurement to the first wireless device.

30. The second wireless device of any one of claims 28 to 29, further configured to receive a third SL PRS from the third wireless device.

31. The second wireless device of any one of claims 28 to 30, further configured to obtain resource allocation information associated with the second SL PRS.

32. The second wireless device of claim 31, wherein the second SL PRS is transmitted in accordance with the resource allocation.

33. The second wireless device of claim 31, wherein the resource allocation is received from at least one of a network node and the first wireless device.

34. The second wireless device of any one of claims 28 to 33, wherein the first, second and third wireless devices belong to a wireless device group.
